(19) United States
(12) Patent Application Publication
(10) Pub. No.: US 2010/0026199 A1
(43) Pub. Date: Feb. 4, 2010

(54) DIELECTRIC BARRIER DISCHARGE LAMP WITH STARTING AID

(75) Inventors: Harald Dellian, Edling (DE); Joerg Rink, Syrgenstein (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/532,162

(22) PCT Filed: Feb. 22, 2008
(86) PCT No.: PCT/EP08/52191

§ 371 Date: Sep. 20, 2009

(30) Foreign Application Priority Data
Mar. 22, 2007 (DE) 20 2007 004 236.1

(51) Int. Cl. H01J 1/00; H05B 41/26

(52) U.S. Cl. 315/246; 313/326

(57) ABSTRACT

A dielectric barrier discharge lamp is provided, which may include an anode and a cathode, a discharge vessel with an exhaust tube, at least one starting electrode which is arranged along the outer side of the exhaust tube, a starting coating, which is arranged in the inner side of the exhaust tube, wherein the starting coating is arranged centrally over the starting electrode, and this starting electrode is connected to the cathode.

### TECHNICAL FIELD

The invention is based on a dielectric barrier discharge lamp.

Application areas of dielectric barrier discharge lamps which are of importance at present are office automation, in particular linear lamps for scanners, fax machines and similar apparatuses, and large-area flat lamps, so-called flat emitters, for backlighting monitors and television screens using liquid crystal technology and other graphic displays. However, the invention is not restricted to these application areas. Instead, there are further application areas, for example in UV treatment in trade and industry, in general lighting, in luminaire design etc.

### PRIOR ART

Dielectric barrier discharge lamps are known per se and are extensively documented in the prior art. They are characterized by the fact that the electrodes are separated from the discharge medium located in the interior of the discharge vessel, typically a noble gas such as xenon or a noble gas mixture, by a dielectric. In this case the electrodes can in principle either all be arranged inside the discharge vessel, all outside the discharge vessel or the electrode(s) of one polarity inside and the other electrode(s) outside the discharge vessel. For electrodes arranged outside the discharge vessel, the wall of the discharge vessel acts as a dielectric barrier. If all of the electrodes are arranged inside the discharge vessel, however, at least one electrode or the electrodes of one polarity need to be separated from the interior of the discharge vessel by a dielectric, for example a dielectric coating. This dielectric barrier results in what is known as a discharge which is dielectrically impeded on one side during operation. Alternatively, all of the inner electrodes can also be provided with a dielectric coating. This is then a discharge which is dielectrically impeded on both sides. The latter relates in particular also to the already mentioned case in which all of the electrodes are arranged outside the discharge vessel.

Owing to the dielectric barrier between at least one electrode and the discharge medium, a voltage which is variable over time, for example a sinusoidal AC voltage, is required for the operation of a dielectric barrier discharge lamp. The pulsed operating mode documented in U.S. Pat. No. 5,604,410 has proven to be particularly efficient.

Document U.S. Pat. No. 6,323,600 has disclosed a circuit arrangement for operating a dielectric barrier discharge lamp in accordance with the previously mentioned pulsed operating mode. For this purpose, voltage pulse trains of a few kilovolts (kV) and pulse repetition rates of typically from 25 to 115 kHz are produced with the aid of a flyback converter.

Owing to the dielectric barrier it is possible to occasionally encounter starting problems, in particular in case of a dielectric barrier on both sides. This reluctance to start generally increases the longer a dielectric barrier discharge lamp has been out of operation. In this case, starting in the dark is particularly difficult. This problem is intended to be alleviated by special starting aids.

EP 1 329 944 has disclosed a tubular dielectric barrier discharge lamp which includes a starting aid integrated in the exhaust tube. For this purpose, two elongated starting electrodes are arranged along the outer side of the exhaust tube and a metallic structure, in particular a starting coating, is arranged centrally between the two starting electrodes inside the exhaust tube.

### DESCRIPTION OF THE INVENTION

The object of the present invention is to specify a dielectric barrier discharge lamp with improved starting properties.

This object is achieved by a dielectric barrier discharge lamp with an anode and a cathode, a discharge vessel with an exhaust tube, at least one starting electrode which is arranged along the outer side of the exhaust tube, a starting coating, which is arranged in the inner side of the exhaust tube, characterized in that the starting coating is arranged centrally over the starting electrode, and this starting electrode is connected to the cathode.

Particularly advantageous refinements are given in the dependent claims.

The inventors have discovered that considerable shortening of the starting time delay is achieved if
1. the starting coating is not simply arranged centrally between the two starting electrodes, as disclosed in the prior art, but is arranged centrally over a starting electrode and, in addition
2. this starting electrode is connected to the cathode or the electrode, which at least temporarily acts as a cathode, at least during the starting phase.

Surprisingly, only the combination of these two measures allows for a considerable shortening of the starting time, whereas each measure on its own only results in a comparatively small improvement.

Preferably, the starting coating is in the form of a semicircle, when viewed in the cross section of the exhaust tube. In a specific embodiment, the starting coating is triangular. In this case, the triangular starting coating is preferably aligned in such a way that one of the three corners of the starting coating points away from the interior of the discharge vessel in the direction toward the sealing point of the exhaust tube. As a result, the two other corners of the triangular starting coating point in the direction toward the anode, as a result of which the electric field strength which can be achieved during the starting operation is obviously increased. It is generally considered decisive, therefore, that the starting coating has an angular shape and that at least one corner points in the direction towards the anode.

The starting coating is manufactured from a material which has a secondary electron emission coefficient which is as high as possible, in particular metal, for example silver.

At present is assumed that the special arrangement of the starting electrode, the negative electrical polarization thereof during the starting phase, and the position of the starting coating relative to the starting electrode particularly favors the field emission of electrodes from the starting coating. Preferably, a further starting electrode is fitted along the exhaust tube opposite the first starting electrode. This second starting electrode is connected, at least during the starting phase, with a positive electrical polarization. As a result, the free electrons are accelerated from the starting coating in the direction of the positive starting electrode and auxiliary discharge is initiated in the exhaust tube. This auxiliary discharge triggers the actual main discharge in the interior of the discharge vessel between the dielectrically impeded (main) electrodes.

The description of the individual features above and below relates to the apparatus category and also to a method corresponding to the invention for starting the lamp according to the invention without this explicitly being mentioned in detail.

In principle, the invention therefore also relates to a method for starting a dielectric discharge lamp with two electrodes, a discharge vessel with an exhaust tube, at least one starting electrode, which is arranged along the outer side of the exhaust tube, a starting coating, which is arranged in the inner side of the exhaust tube, wherein the starting coating is arranged centrally over the starting electrode, and the method steps to the effect that the electrodes of the dielectric barrier discharge lamp are connected to an electrical operating device designed for producing high-voltage pulses by means of connecting cables and that the electrical polarization and control for the generation of the high-voltage pulses is such that the electrode which is connected to the starting electrode arranged centrally over the starting coating acts as a cathode, at least during a starting phase of the lamp.

### BRIEF DESCRIPTION OF THE DRAWINGS

The invention will be explained in more detail below with reference to an exemplary embodiment. In the figures:

FIG. 1a shows a dielectric barrier discharge lamp according to the invention in an illustration of a partial longitudinal section,

FIG. 1b shows the lamp shown in FIG. 1a in a cross-sectional illustration along the line AA,

FIG. 2 shows a lighting system according to the invention with the lamp shown in FIG. 1a, and

FIG. 3 shows a schematic envelope illustration of high-voltage pulses for the starting and the operation of the lamp shown in FIG. 1a.

### PREFERRED EMBODIMENT OF THE INVENTION

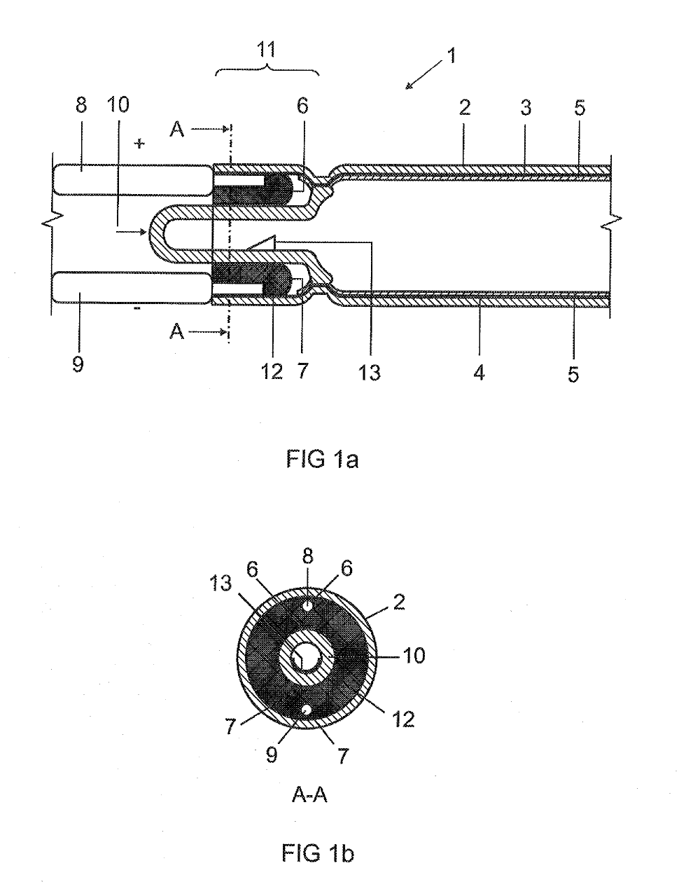

FIGS. 1a and 1b show a partial longitudinal section and, respectively, a cross section along line AA of an exemplary embodiment of the invention, in a schematic illustration. The lamp is an elongated, dielectric barrier discharge lamp 1 which is intended in particular for use in appliances for office automation.

The dielectric barrier discharge lamp 1 substantially includes a tubular discharge vessel 2 with a circular cross section (only partially illustrated in FIG. 1a), two strip-shaped inner main electrodes 3, 4, which are each covered by a dielectric barrier 5, for example a glass solder strip, two U-shaped outer auxiliary electrodes 6, 7 and two electrical supply cables 8, 9, which are provided for the connection of an electrical supply device (not illustrated in FIG. 1a).

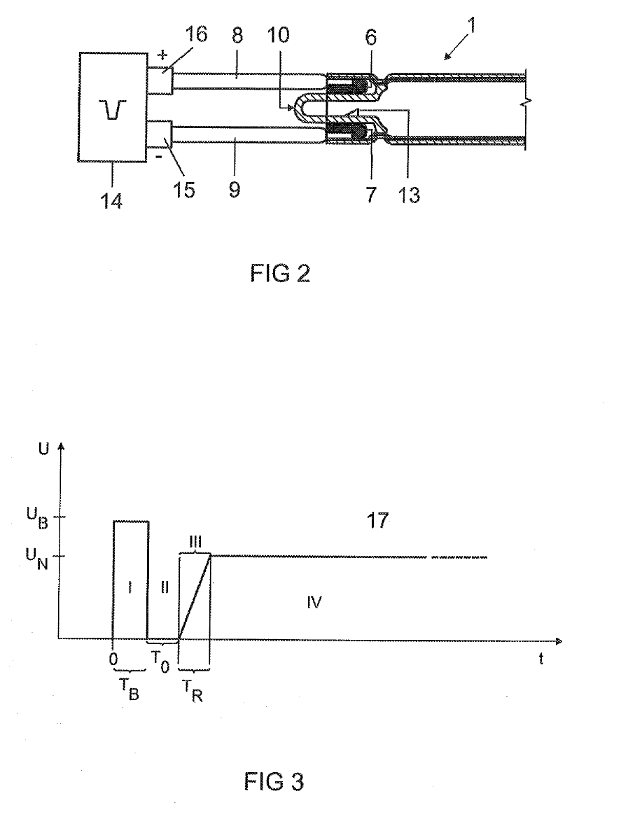

The strip-shaped main electrodes 3, 4 are arranged diametrically with respect to one another on the inner side of the tubular discharge vessel 2. The basic principle of such dielectric barrier discharge lamps with inner main electrodes is explained in detail in the document U.S. Pat. No. 6,097,155, in particular in conjunction with FIGS. 1a, 1b and 2 therein.

The tubular discharge vessel 2 is sealed in a gas-tight manner at its first end with the aid of a plate-like fuse seal with the exhaust tube 10 sealed off. At its other end, the tubular discharge vessel 2 is sealed in the form of a dome (not illustrated in FIG. 1a). Xenon with a fill pressure of approximately 15 kilopascals (kPa) is located in the interior of the discharge vessel 2. The strip-shaped main electrodes 3, 4 are passed through the plate-like fuse seal toward the outside. For this purpose, the discharge tube has a section 11 which protrudes beyond the plate-like fuse seal.

In each case a first limb of the U-shaped auxiliary electrodes 6, 7 is connected to the electrical supply cables 8, 9 inside the discharge tube section 11. The respective other limb of the U-shaped auxiliary electrodes 6, 7 touches the outer side of the sealed-off exhaust tube 10.

For this purpose, the two U-shaped auxiliary electrodes 6, 7 are arranged diametrically with respect to one another in the interspace between the exhaust tube 10 and the adjacent inner side of the surrounding discharge tube section 11. The interspace is filled with a silicone rubber 12 for electrical insulation purposes. This can also be dispensed with, if appropriate, in the case of less stringent requirements being placed on the insulation. A starting coating 13 which consists of silver solder and is in the form of a semicircle in cross section is arranged directly opposite one auxiliary electrode 7 (see FIG. 1b). When viewed in longitudinal section, the starting coating 13 has a triangular shape, with the base of the triangle pointing in the circumferential direction of the exhaust tube 10, and the tip pointing away from the interior of the discharge vessel and in the direction of the sealed-off end of the exhaust tube. It is also critical for achieving the complete success in accordance with the invention that the auxiliary electrode 7 over which the starting coating 13 is arranged centrally is provided as the cathode, i.e. is at least temporarily connected to the negative electrical potential during a preferably pulsed starting phase. As a result, the two other corners of triangular starting coating 13, which is oriented as described above, point in the direction of the anode.

FIG. 2 is a schematic illustration of a lighting system according to the invention. It substantially includes the dielectric barrier discharge lamp 1 according to the invention shown in FIGS. 1a, 1b and an electrical supply device 14 designed for pulsed operation. In this case, the connecting cable 9, which is connected to the first auxiliary electrode 7 which is directly adjacent to the starting coating 13, is connected to the negative terminal 15 of the supply device 14. The other auxiliary electrode 6 is connected to the positive terminal 16 of the supply device 14 via the other connecting cable 8. This ensures that the first electrode 7 assumes, in pulsed fashion, a negative electrical potential in comparison with the other auxiliary electrode 6, at least during the starting phase of the lamp 1. It has been demonstrated that, with this polarization, the field emission of electrons from the starting coating is favored. The free electrons generated by the field emission from the starting coating are then accelerated towards the positive other auxiliary electrode 6 and in this way start an auxiliary discharge in the exhaust tube. The auxiliary discharge then triggers the actual main discharge inside the discharge vessel 2 between the main electrodes 3, 4.

FIG. 3 shows a schematic illustration of the envelope 17 of high-voltage pulses for the starting and operation of the lamp 1 shown in FIG. 1a, as they are generated, for example, by the electrical operating device 14 shown in FIG. 2 at the output poles 15, 16 (the envelope is in this case indicated as being positive for illustrative purposes). The envelope 17 can be split into four phases, in which the amplitudes of the high-voltage amplitudes of the high-voltage pulses are different. In phase I, the so-called boost phase, the amplitude U_{B} is higher than during normal operation, which is indicated by the phase IV. The boost phase begins at time t=0 and lasts for the duration T_{B}. Then there is the break phase II, in which the amplitude is zero during the duration T₀, i.e. no high-voltage pulses are generated. There then follows the ramp phase III, during which the amplitude increases linearly from zero to the conventional normal value U_{N} during the normal operation phase IV. Owing to the combination in accordance with the invention of the specific arrangement of the starting coating and the polarization of the next auxiliary electrode, a marked reduction in the total duration of the starting sequence, i.e. phases I to III is achieved, as the following comparison of typical durations shows.

| | T_{B} | T₀ | T_{R} | T_{Total} |
|---|---|---|---|---|
| Conventional | 50 ms | 30 ms | 60 ms | 140 ms |
| In accordance with the | 10 ms | 20 ms | 60 ms | 90 ms |
| invention | | | | |

The invention therefore makes it possible to reduce the total duration T_{Total} (=T_{B}+T₀+T_{R}) for the starting sequence from typically 140 ms to approximately 90 ms, with the reliability of the starting of the lamp being maintained. In particular the following ranges have proven to be favorable choices for the three phases of the starting sequence:
Boost phase [in ms]: 5≦TB≦15
Break-phase [in ms]: 10≦T₀≦20
Ramp-phase [in ms]: 40≦T_{R}≦70

1. A dielectric barrier discharge lamp, comprising:
an anode and a cathode,
a discharge vessel with an exhaust tube,
at least one starting electrode which is arranged along the outer side of the exhaust tube,
a starting coating, which is arranged in the inner side of the exhaust tube,
wherein the starting coating is arranged centrally over the starting electrode, and this starting electrode is connected to the cathode.

2. The dielectric barrier discharge lamp as claimed in claim 1, wherein the starting coating is in the form of a semicircle, when viewed in the cross section of the exhaust tube.

3. The dielectric barrier discharge lamp as claimed in claim 1, wherein the starting coating has an angular shape, and at least one corner points in the direction toward the anode.

4. The dielectric barrier discharge lamp as claimed in claim 3, wherein the shape of the starting coating is triangular.

5. The dielectric barrier discharge lamp as claimed in claim 4, wherein one of the three corners of the starting coating points away from the interior of the discharge vessel in the direction toward the sealing point of the exhaust tube.

6. The dielectric barrier discharge lamp as claimed in claim 1, wherein the starting coating is made from a metallic material.

7. The dielectric barrier discharge lamp as claimed in claim 6, wherein the metallic material for the starting coating is a silver solder.

8. The dielectric barrier discharge lamps as claimed in claim 1, wherein a second starting electrode is arranged opposite the first starting electrode along the outer side of the exhaust tube, and wherein the second starting electrode is connected to the anode.

9. A lighting system, comprising:
a dielectric barrier discharge lamp, comprising:
an anode and a cathode,
a discharge vessel with an exhaust tube,
at least one starting electrode which is arranged along the outer side of the exhaust tube,
a starting coating, which is arranged in the inner side of the exhaust tube,
wherein the starting coating is arranged centrally over the starting electrode, and this starting electrode is connected to the cathode; and
an electrical operating device, which is designed for generating high-voltage pulses and is connected by means of connecting cables to the electrodes of the dielectric barrier discharge lamp, wherein the electrical polarization and control for the generation of the high-voltage pulses is such that the electrode which is connected to the starting electrode arranged centrally over the starting liner acts as cathode at least during a starting phase of the lamp.

10. The lighting system as claimed in claim 9, wherein the starting coating has an angular shape and at least one corner points in the direction toward the anode.
